(19) United States
(12) Patent Application Publication
(10) Pub. No.: US 2023/0136387 A1
(43) Pub. Date: May 4, 2023

(54) SYSTEM AND METHOD FOR IDENTIFYING TRUTHFULNESS OF A DISPOSITION IN A CONTACT CENTER

(71) Applicant: NICE LTD., Ra'anana (IL)

(72) Inventors: Ganesh KSHIRSAGAR, District Solapur (IN); Mahesh Gutal, Andhra Pradesh Chittoor (IN); Piyush Tayde, Hadpasar (IN); Salil Dhawan, Pune (IN); Sushank Dahiwadkar, Baner (IN)

(21) Appl. No.: 17/515,472

(22) Filed: Oct. 31, 2021

(51) Int. Cl. G06N 5/02; G06F 16/33

(52) U.S. Cl. CPC G06N 5/022; G06F 16/3344

(57) ABSTRACT

A computerized-method for identifying truthfulness of a disposition, in a contact center is provided herein. The computerized-method includes: (a) receiving an interaction transcript and related disposition of an interaction; (b) providing the received interaction transcript and related disposition to an Artificial-Intelligence (AI) model to calculate: (i) a disposition confidence score related to the agent; and (ii) a general disposition confidence score related to all agents; (c) operating a data aggregator module on a database to aggregate data related to the agent; (d) providing the disposition confidence score related to the agent, the general disposition confidence score related to all agents and the data related to the agent to a disposition-truthfulness-calculator module to calculate a Disposition Truthfulness Score (DTS); and (e) sending the DTS to the one or more applications, to take one or more follow-up actions based on the DTS, when the DTS is below a preconfigured disposition-truthfulness-threshold.

### TECHNICAL FIELD

The present disclosure relates to the field of data analysis for identifying truthfulness of a call disposition to minimize related poor business decisions.

### BACKGROUND

Call disposition is an integral feature of contact center systems. A call disposition describes the outcome of the call. It helps to understand the content of an interaction and facilitates the reporting and quality management. Disposition plays a crucial role in sales campaign evaluation, calculate agent's effectiveness in handling a specific type of interactions etc. Hence, valid call dispositions are an effective means for a contact center evaluation.

Commonly, the call disposition is entered by the agent at the end of the interaction with a customer. However, this manually entered call disposition, which is selected from a dropdown closed menu, by the agent, may not reflect the truthfulness of the call disposition related with the actual interaction. Having such a non-valid call disposition, in the contact center system, may create a false alarm that may affect business decisioning in the contact center system. Moreover, erroneous call disposition may lead to ineffective campaigning, inefficient management decisions and the like.

For example, during a sales campaign, every agent may enter the outcome of the interaction with the customer as a call disposition by selecting from a predetermined list, e.g., a dropdown menu. When an evaluator, such as a supervisor may evaluate the sales campaign based on the call disposition the evaluation may be distorted or inaccurate when the call dispositions are unreliable.

Therefore, there is a need for a technical solution to identify truthfulness of a call disposition which plays a very crucial part at contact centers, as it is one of the underlying factors for driving the business.

### SUMMARY

There is thus provided, in accordance with some embodiments of the present disclosure, a computerized-method for truthfulness of a disposition, in a contact center.

Furthermore, in accordance with some embodiments of the present disclosure, the computerized-method includes: (a) receiving an interaction transcript and related disposition of an interaction between an agent and a customer; (b) providing the received interaction transcript and related disposition to a prebuilt Artificial Intelligence (AI) model to calculate: (i) a disposition confidence score related to the agent; and (ii) a general disposition confidence score related to all agents; (c) operating a data aggregator module on a database to aggregate data related to the agent; (d) providing the disposition confidence score related to the agent, the general disposition confidence score related to all agents and the data related to the agent to a disposition truthfulness calculator module to calculate a Disposition Truthfulness Score (DTS); and (e) sending the DTS to the one or more applications, to take one or more follow-up actions based on the DTS, when the DTS is below a preconfigured disposition truthfulness threshold.

Furthermore, in accordance with some embodiments of the present disclosure, the pretrained AI model may be prebuilt by: (i) retrieving interactions transcripts and related dispositions during a preconfigured period; (ii) preprocessing the retrieved interactions transcripts and related disposition; (iii) providing the preprocessed interactions transcripts and related disposition to an NLP module to tokenize the preprocessed interactions transcripts into tokens and encode the tokens; and (iv) using the encoded tokens to build and train the AI model.

Furthermore, in accordance with some embodiments of the present disclosure, the related disposition may be manually entered by an agent at the end of the interaction by selecting from a list of options.

Furthermore, in accordance with some embodiments of the present disclosure, the disposition confidence score related to the agent for the received interaction transcript of the interaction may be calculated by the AI module by operating a Manually Entered Disposition Confidence Score (MEDCS) module based on agent's interactions transcripts and dispositions related to interactions conducted in a preconfigured period by the agent and based on the received interaction transcript and related disposition of the interaction between the agent and the customer.

Furthermore, in accordance with some embodiments of the present disclosure, the general disposition confidence score related to all agents for the received interaction transcript of the interaction may be calculated by the AI module by operating a General Disposition Confidence Score (GDCS) module. The GDCS module may be based on agents' interactions transcripts and dispositions related to interactions conducted in a preconfigured period by all agents and based on the received interaction transcript and related disposition of the interaction between the agent and the customer.

Furthermore, in accordance with some embodiments of the present disclosure, the aggregated data related to the agent for the received interaction transcript of the interaction may be the agent's sentiment score for the interaction, an occupancy rate of the agent for a specified period, skills, ratings and duty cycle factor for a specified period.

Furthermore, in accordance with some embodiments of the present disclosure, one application of the one or more applications may be a Quality Management (QM) application. The one or more follow-up actions of the QM application based on the disposition truthfulness score may be assigning a coaching program by an evaluator.

Furthermore, in accordance with some embodiments of the present disclosure, one application of the one or more applications may be a Workforce Management (WFM) application. The one or more follow-up actions of the WFM application based on the disposition truthfulness score may include an optimized assignment to agents.

Furthermore, in accordance with some embodiments of the present disclosure, one application of the one or more applications may be a supervisor application. The computerized-method may be further comprising displaying the disposition confidence score related to the agent on a supervisor dashboard of the supervisor application, via a display unit. The one or more follow-up actions of the supervisor application based on the disposition truthfulness score may include a supervisor agent communication.

Furthermore, in accordance with some embodiments of the present disclosure, the Disposition Truthfulness Score (DTS) may be calculated based on formula I:

DTS=DCS+AIS+AOF−DCF (I)

whereby:
DCS is calculated based on formula II,

$$Disposition Confidence Score = ( \frac{MEDCS + GDCS}{2} ) \times F 1 \qquad ( II )$$

whereby:
   MEDCS is a Manually Entered DCS, which is the calculated disposition confidence score related to the agent,
   GDCS is a General DCS, which is the calculated disposition confidence score related to all agents, and
F1 is a weight;
AIS is calculated based on formula III:

$$Agent Interaction Specifics = ( \frac{AS + ASS}{2} ) \times F 2 \qquad ( III )$$

whereby:
   AS is Agent's sentiments score for the interaction,
   ASS is Agent's skills score,
   F2 is a weight;
   AOF is calculated based on formula IV:

$$Agent Other Factors = ( \frac{AOR + AR}{2} ) \times F 3 \qquad ( IV )$$

whereby:
   AOR is Agents Occupancy Rate for a specified period, and
   AR is Agent ratings;
   F3 is a weight; and
   DCF is calculated based on formula V:

Duty Cycle Factors=RDCF×F4 (V)
whereby:
   RDCF is Raw Duty Cycle Factor for a specified period, and
   F4 is a weight.

There is further provided, in accordance with some embodiments of the present invention, a computerized-system for identifying truthfulness of a disposition, in a contact center.

Furthermore, in accordance with some embodiments of the present disclosure, the computerized-system may include: one or more processors, a database, and a memory to store the database.

Furthermore, in accordance with some embodiments of the present disclosure, the one or more processors may be configured to: (a) receive an interaction transcript and related disposition of an interaction between an agent and a customer; (b) provide the received interaction transcript and related disposition to a prebuilt Artificial Intelligence (AI) model to calculate: (i) a confidence disposition score related to the agent; and (ii) a general disposition confidence score related to all agents; (c) operate a data aggregator module on the database to aggregate data related to the agent; (d) provide the disposition confidence score related to the agent, the general disposition confidence score related to all agents and the data related to the agent to a disposition truthfulness calculator module to calculate a Disposition Truthfulness Score (DTS); and (e) send the DTS to the one or more applications, to take one or more follow-up actions based on the DTS, when the DTS is below a preconfigured disposition truthfulness threshold.

### BRIEF DESCRIPTION OF THE DRAWINGS

FIGS. 1A-1B schematically illustrate a high-level diagram of a computerized-system for identifying truthfulness of a disposition, in a contact center, in accordance with some embodiments of the present disclosure;

FIGS. 2A-2B are a high-level workflow of a computerized-method for identifying truthfulness of a disposition, in a contact center, in accordance with some embodiments of the present disclosure;

FIG. 3 schematically illustrates a high-level diagram of building an Artificial Intelligence (AI) module to calculate a disposition confidence score related to the agent and a general disposition confidence score related to all agents, in accordance with some embodiments of the present disclosure;

FIG. 4A is a table showing a comparison of existing classification algorithms and computerized-method for identifying truthfulness of a disposition, in a contact center, in accordance with some embodiments of the present disclosure;

FIG. 4B is a table showing a deep learning model summary, in accordance with some embodiments of the present disclosure;

FIG. 5 is a high-level workflow of a computerized-method for identifying truthfulness of a disposition, in a contact center in a contact center, in accordance with some embodiments of the present disclosure;

FIG. 6 is a screenshot of a supervisor dashboard of the supervisor application showing an average Disposition Truthfulness Score (DTS), in accordance with some embodiments of the present disclosure;

FIG. 7 is a screenshot of a supervisor dashboard of the supervisor application showing a list of dispositions and related DTS, in accordance with some embodiments of the present disclosure; and

FIG. 8 shows an example of an implementation of a computerized-method and a computerized-system for identifying truthfulness of a disposition, in a contact center, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “duty cycle”, as used herein, refers to a time period analogues to shift in which the agent operates.

The terms “customer sentiment” and “customer rating” are interchangeable.

The term “disposition” as used herein, refers to a call disposition. A call disposition is an integral feature of the contact center systems. A call disposition describes the outcome of a call and summaries the content of an interaction and facilitates the reporting and quality management. At the end of each interaction, an agent selects a call disposition from a dropdown closed menu.

The call disposition plays a crucial role at a later stage in sales campaign evaluation, calculate agent's effectiveness in handling a specific type of interactions and the like. Hence, valid call dispositions are an effective means for contact center evaluation.

However, a call disposition that have been entered by the agent may not reflect the truthfulness of the actual interaction, which may create a false alarm that affects the decisioning in the contact center system. Erroneous call dispositions may lead to ineffective campaigning, inefficient management decisions etc. Call dispositions may save 10-15% of agents' time in After Call Work (ACW), thus resulting in efficient use of agent's time and make sure insights shared by the agent, after the interaction, are accurate as many underlying processes in the contact center system are dependent on that. For example, during an outbound call campaign the agents may select at the end of an interaction with a customer one of two options of the call disposition: “interested” or “not interested”. Based on the call dispositions, an evaluator, such as a supervisor may analyze the effectiveness of the campaign. Thus, a relatively high number of a particular call outcome can alert sales of an opportunity or problem.

Therefore, when a call disposition is not selected accurately by the agent, an opportunity or a problem which may require an immediate attention may be overlooked and unattended. For example, if there is high amount of calls as part of outbound campaign which is supposed to lead to more appointments, if that's not getting reflected correctly in the call dispositions then, issues such as the agent is not selecting a correct call disposition or such as underperformance of the campaign may be overlooked and unattended.

For a contact center, truthfulness of call dispositions may lead to accurate interaction disposition saved, resulting in an incremental improvement in customer experience, which may contribute to Net Promoter Score (NPS) growth. An average NPS growth of 7% may correlate with a 1% growth in revenue. Moreover, effective evaluations of the agents may lead to a better agent engagement and an increased job satisfaction which may result in reduced attrition costs. An effective and right evaluation of the agents makes sure agents are not assigned coaching packages incorrectly and not demotivating agents in the progress. A truthfulness of a call disposition may actually ensure accurate assessment of agent skill as regards call disposition is evaluated

Accurate call dispositions may also improve operational efficiency and reduce attrition which may lead to low turnover rates resulting in decreased new hire and onboarding costs. Each new agent hiring bears costs such as, training, direct recruiting costs, and lost productivity during ramp up. Furthermore, since agent performance gaps may be timely identified and appropriate mitigation measures taken, customer experience may not be impacted which is a prime goal of any contact center. An inaccurate call disposition may create misunderstanding of the customer call summary. When a different agent may take over that query with the customer, then it may lead to a bad customer experience. Moreover, by identifying a truthfulness of a disposition, the agent performance gaps may be identified, and adequate coaching assignments may be assigned accordingly.

Accordingly, there is a need for a technical solution to identify truthfulness of a disposition which plays a very crucial part at contact centers, as it is one of the underlying factors for driving the business.

Moreover, there is a need for a system and method for identifying truthfulness of a disposition, in a contact center.

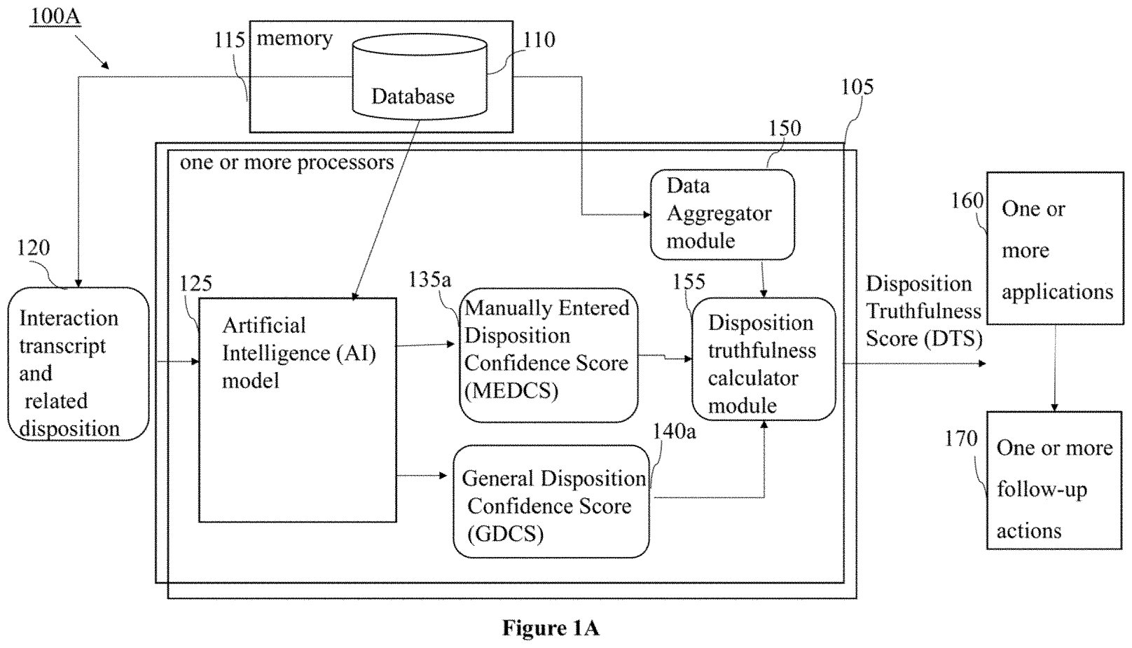

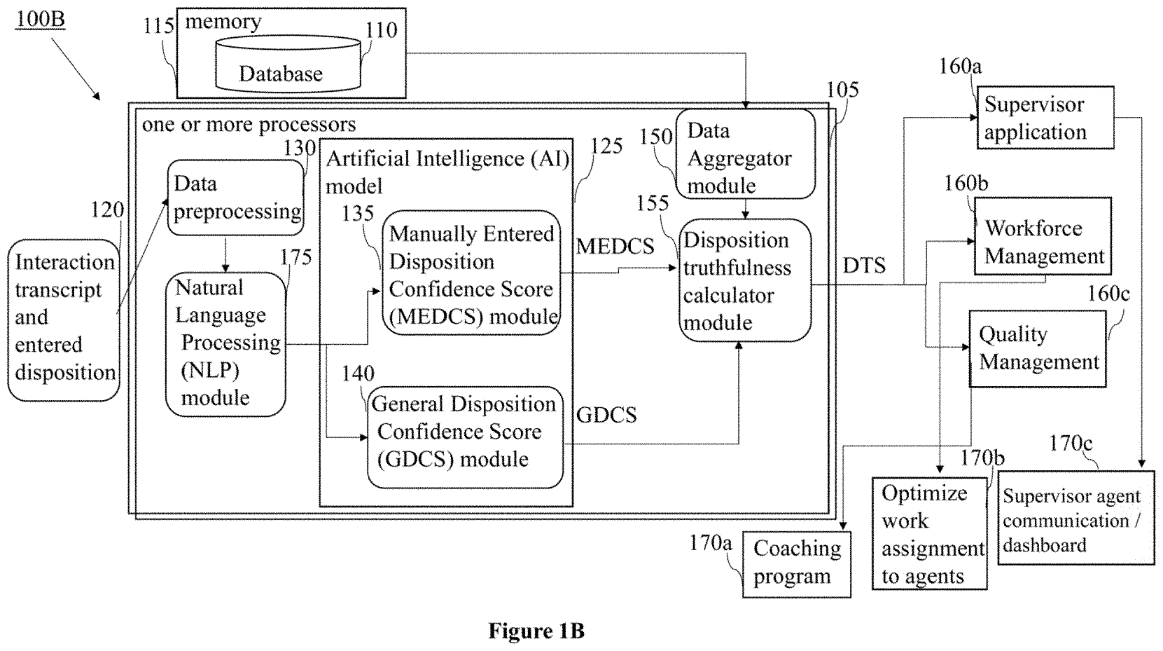

FIG. 1A schematically illustrates a high-level diagram of a computerized-system 100A for identifying truthfulness of a disposition, in a contact center, in accordance with some embodiments of the present disclosure.

According to some embodiments of the present disclosure, a computerized-system, such as computerized-system 100A for identifying truthfulness of a disposition, in a contact center, may include one or more processors 105, a database 110 and a memory 115 to store the database.

According to some embodiments of the present disclosure, the one or more processors 105 may be configured to receive an interaction transcript and related disposition 120 of an interaction between an agent and a customer.

According to some embodiments of the present disclosure, the interaction transcript and related disposition 120 may be retrieved from a database, such as database 110 which is stored in memory 115.

According to some embodiments of the present disclosure, the received interaction transcript and related disposition 120 may be provided a prebuilt Artificial Intelligence (AI) model, such as AI model 125. The AI model 125 may calculate a disposition confidence score related to the agent, such as Manually Entered Disposition Confidence Score (MEDCS) 135a and a general disposition confidence score related to all agents, such as general Disposition Confidence Score (GDCS) 140a.

According to some embodiments of the present disclosure, a data aggregator module, such as data aggregator module 150, may be operated on a database, such as database 110 to aggregate data related to the agent and then providing the disposition confidence score related to the agent, the general disposition confidence score related to all agents and the data related to the agent to a module, such as disposition truthfulness calculator module 155 to calculate a Disposition Truthfulness Score (DTS). The data related to the agent for the received interaction transcript of the interaction is agent's sentiment score for the interaction, occupancy rate of the agent for a specified period, skills, ratings and duty cycle factor for a specified period.

According to some embodiments of the present disclosure, the Disposition Confidence Score (DTS) may be calculated based on formula I:

DTS=DCS+AIS+AOF−DCF (I)
whereby:
   DCS is calculated based on formula II,

$$Disposition Confidence Score = ( \frac{MEDCS + GDCS}{2} ) \times F 1 \qquad ( II )$$

whereby:
MEDCS is a Manually Entered DCS, which is the calculated disposition confidence score related to the agent,
GDCS is a General DCS, which is the calculated disposition confidence score related to all agents, and
F1 is a weight;
AIS is calculated based on formula III:

$$Agent Interaction Specifics = ( \frac{AS + ASS}{2} ) \times F 2 \qquad ( III )$$

whereby:
AS is Agent's sentiments score for the interaction,
ASS is Agent's skills score,
F2 is a weight;
AOF is calculated based on formula IV:

$$Agent Other Factors = ( \frac{AOR + AR}{2} ) \times F 3 \qquad ( IV )$$

whereby:
AOR is Agents Occupancy Rate for a specified period, and
AR is Agent ratings;
F3 is a weight;
and
DCF is calculated based on formula V:

Duty Cycle Factors=RDCF×F4 (V)
whereby:
RDCF is Raw Duty Cycle Factor for a specified period, and
F4 is a weight.

According to some embodiments of the present disclosure, the calculated DTS may be sent to the one or more applications 160, to take one or more follow-up actions 170 based on the calculated DTS, when the calculated DTS is below a preconfigured disposition truthfulness threshold.

According to some embodiments of the present disclosure, the related disposition may be manually entered by an agent at the end of the interaction by selecting from a list of options, e.g., a dropdown of a closed menu.

FIG. 1B schematically illustrates a high-level diagram of a computerized-system 100B for identifying truthfulness of a disposition, in a contact center, in accordance with some embodiments of the present disclosure.

According to some embodiments of the present disclosure, a computerized-system, such as computerized-system 100B for identifying truthfulness of a disposition, in a contact center may include the same components of computerized-system 100A in FIG. 1A. One or more processors 105, a database 110 and a memory 115 to store the database.

According to some embodiments of the present disclosure, the one or more processors 105 in the computerized-system for identifying truthfulness of a disposition, in a contact center 100B, may be configured to receive an interaction transcript and related disposition 120 of an interaction between an agent and a customer.

According to some embodiments of the present disclosure, the interaction transcript and related disposition 120 may be retrieved from a database, such as database 110 which is stored in memory 115.

According to some embodiments of the present disclosure, the received interaction transcript and related disposition 120 may be provided to data preprocessing, such as data preprocessing 130 and then the processed data may be provided to a prebuilt Artificial Intelligence (AI) model, such as AI model 125. The AI model 125 may calculate a disposition confidence score related to the agent, such as Manually Entered Disposition Confidence Score (MEDCS) 135a and a general disposition confidence score related to all agents, such as general Disposition Confidence Score (GDCS) 140a.

According to some embodiments of the present disclosure, the disposition confidence score related to the agent for the received interaction transcript of the interaction may be calculated by the AI module 125 by operating a module, such as Manually Entered Disposition Confidence Score (MEDCS) module 135 based on agent's interactions transcripts and dispositions related to interactions conducted in a preconfigured period by the agent and the received interaction transcript and related disposition of the interaction between the agent and the customer.

According to some embodiments of the present disclosure, the general disposition confidence score related to all agents for the received interaction transcript of the interaction may be calculated by the AI module 135 by operating a module, such as General Disposition Confidence Score (GDCS) module 140 and the GDCS module is based on agents interactions transcripts and dispositions related to interactions conducted in a preconfigured period by all agents and the received interaction transcript and related disposition of the interaction between the agent and the customer.

According to some embodiments of the present disclosure, the MEDCS module 135 and the GDCS module 140 may receive the interaction's transcript and entered disposition 120 after a module, such as Natural Language Processing (NLP) module 175 has processed the interactions transcript and entered disposition 120, which has been processed by data processing 130, to tokenize the interaction's transcript, and then the pre-processed tokens and the manually entered disposition may be fed to a prebuilt machine learning model, such as AI model 125.

According to some embodiments of the present disclosure, a data aggregator module, such as data aggregator module 150, may be operated on a database, such as database 110 to aggregate data related to the agent and then providing the disposition confidence score related to the agent, the general disposition confidence score related to all agents and the data related to the agent to a module, such as disposition truthfulness calculator module 155 to calculate a Disposition Truthfulness Score (DTS). The data related to the agent for the received interaction transcript of the interaction may be agent's sentiment score for the interaction, occupancy rate of the agent for a specified period, skills, ratings and duty cycle factor for a specified period.

According to some embodiments of the present disclosure, one application of the one or more applications may be a Quality Management (QM) application 160c. The one or more follow-up actions of the QM application 160c, which may be based on the DTS, may be assigning a coaching program 170a by an evaluator.

According to some embodiments of the present disclosure, one application of the one or more applications is a Workforce Management (WFM) application 160b. The one or more follow-up actions of the WFM application based on the disposition truthfulness score, may include an optimized assignment to agents 170b.

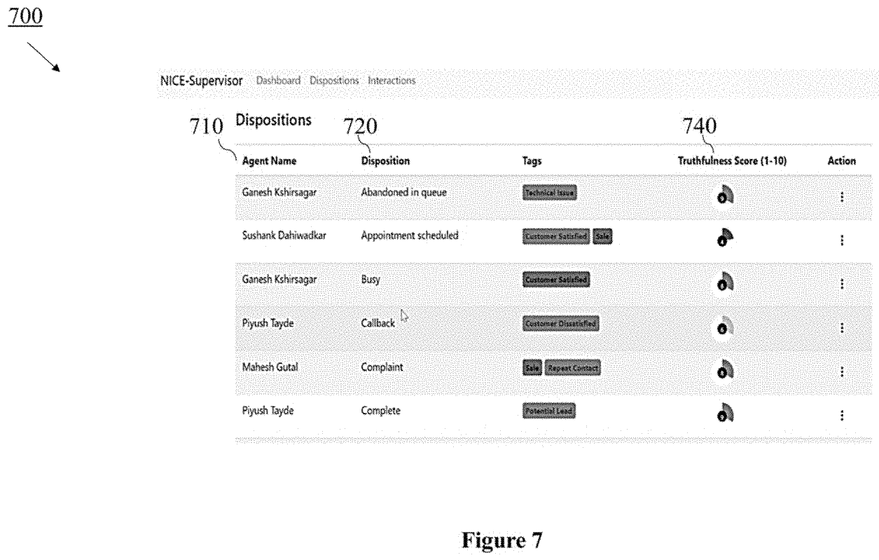

According to some embodiments of the present disclosure, one application of the one or more applications may be a supervisor application 160a, and the disposition and related DTS of each agent may be displayed on a supervisor dashboard of the supervisor application 160a, via a display unit, as shown in screenshot 700 in FIG. 7.

According to some embodiments of the present disclosure, the one or more follow-up actions of the supervisor application 160a, based on the DTS, may include a supervisor agent communication related to the agent's performance or presenting via a supervisor dashboard the agent disposition and related truthfulness score, as shown in screenshot in FIG. 7, to enable the supervisor to arrange an adequate trainings for the agent to improve the performance 170c.

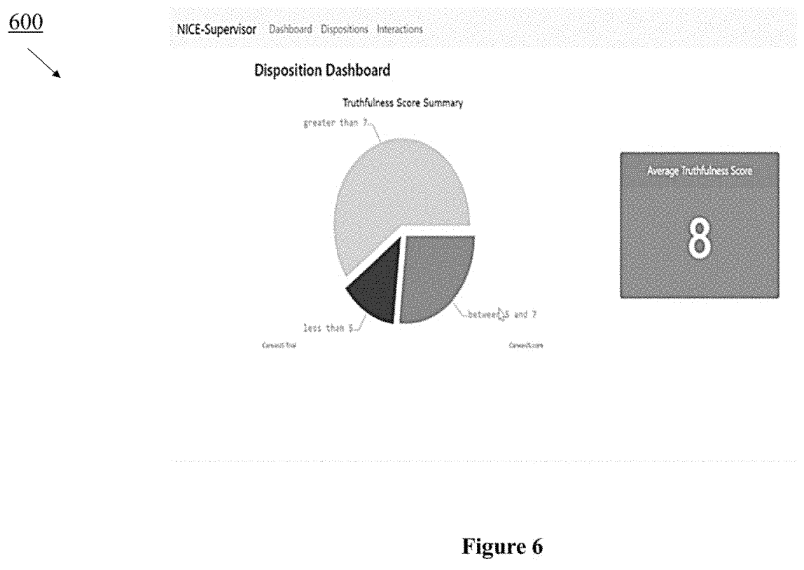

According to some embodiments of the present disclosure, an average DTS score may be presented on a supervisor dashboard, as shown in screenshot 600 in FIG. 6.

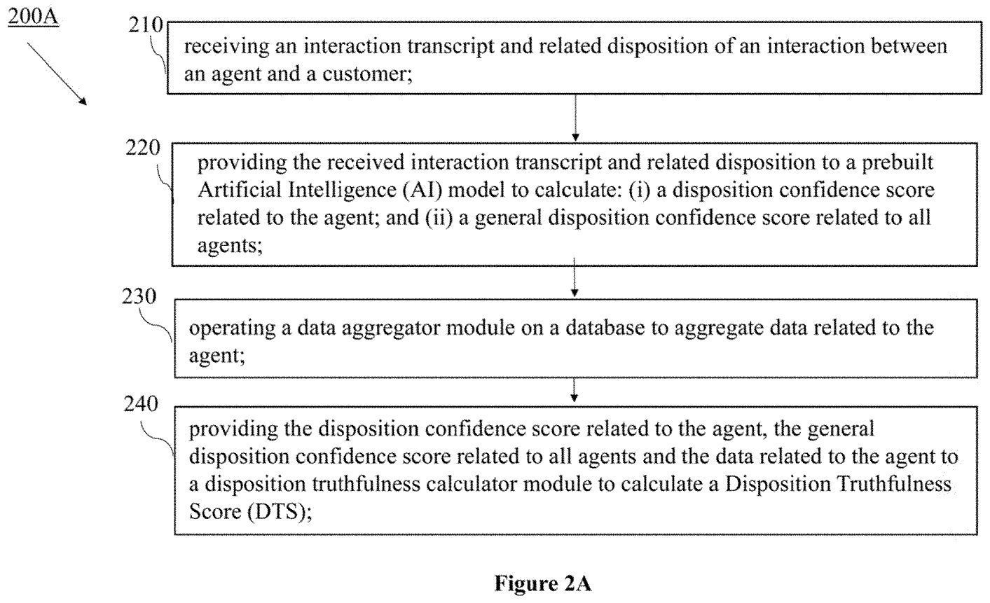

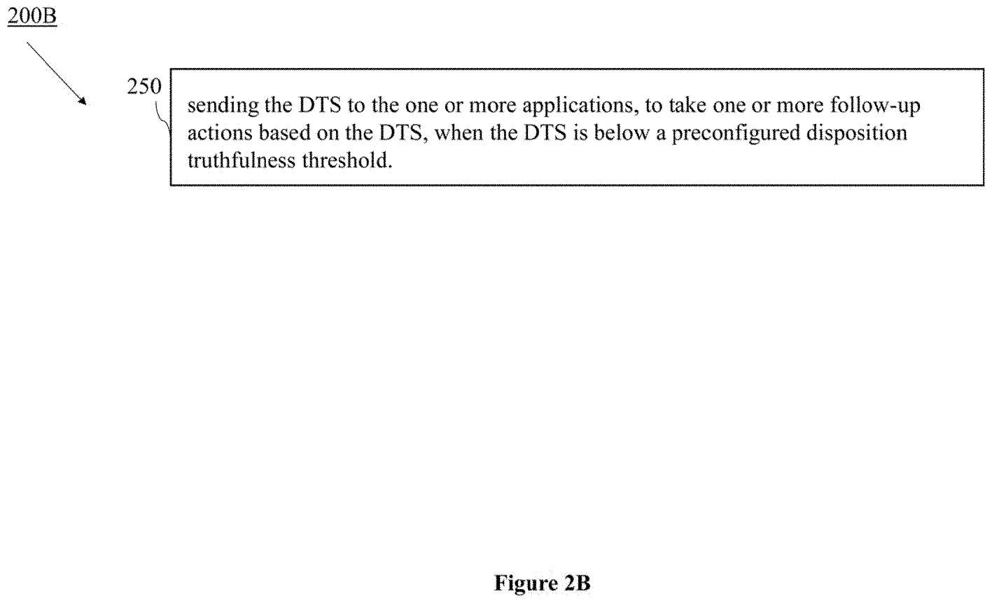

FIGS. 2A-2B are a high-level workflow of a computerized-method 200 for identifying truthfulness of a disposition, in a contact center, in accordance with some embodiments of the present disclosure.

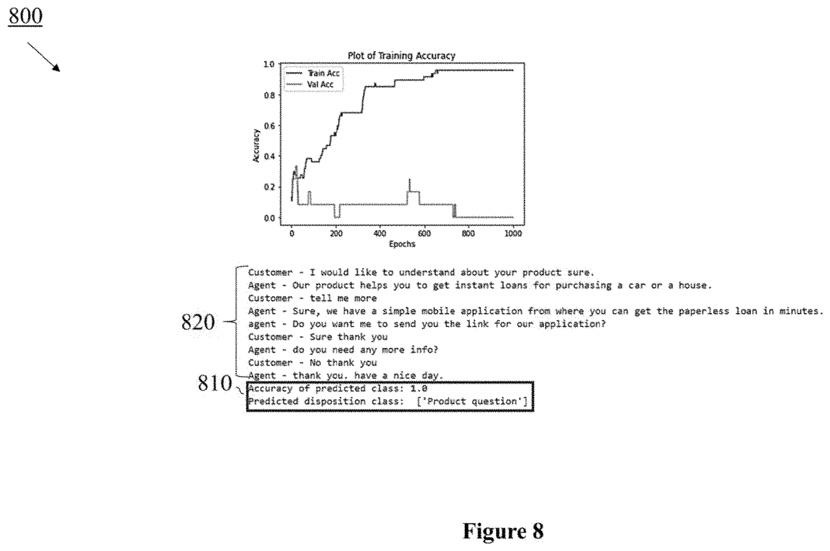

According to some embodiments of the present disclosure, operation 210 may comprise receiving an interaction transcript and related disposition of an interaction between an agent and a customer. The received interaction transcript and related disposition of an interaction between an agent and a customer may be such as interaction transcript and related disposition 120 in FIGS. 1A-1B and such as elements 810 and 820 in FIG. 8.

According to some embodiments of the present disclosure, operation 220 may comprise providing the received interaction transcript and related disposition to a prebuilt Artificial Intelligence (AI) model to calculate: (i) a disposition confidence score related to the agent; and (ii) a general disposition confidence score related to all agents. The prebuilt AI model may be a model such as AI model 125 in FIGS. 1A-1B.

According to some embodiments of the present disclosure, operation 230 may comprise operating a data aggregator module on a database to aggregate data related to the agent. The data aggregator module may be a module such as data aggregator module 150 in FIGS. 1A-1B, which may be operating on a database, such as database 110 in FIGS. 1A-1B.

According to some embodiments of the present disclosure, operation 240 may comprise providing the disposition confidence score related to the agent, the general disposition confidence score related to all agents and the data related to the agent to a disposition truthfulness calculator module to calculate a Disposition Truthfulness Score (DTS). The disposition truthfulness calculator module may be a module such as disposition truthfulness calculator module 155 in FIGS. 1A-1B.

According to some embodiments of the present disclosure, operation 250 may comprise sending the DTS to the one or more applications, to take one or more follow-up actions based on the DTS, when the DTS is below a preconfigured disposition truthfulness threshold.

According to some embodiments of the present disclosure, the one or more applications may be supervisor application 160a in FIG. 1B, workforce management 160b in FIG. 1b and Quality management 160c in FIG. 1B. the one or more follow-up actions may be assigning the agent to a coaching program 170a in FIG. 1B, optimizing work assignment to agents 170b and a supervisor agent communication related to the agent's performance or presenting via a supervisor dashboard the agent disposition and related truthfulness score, as shown in screenshot in FIG. 7, to enable the supervisor to arrange an adequate trainings for the agent to improve the performance 170c.

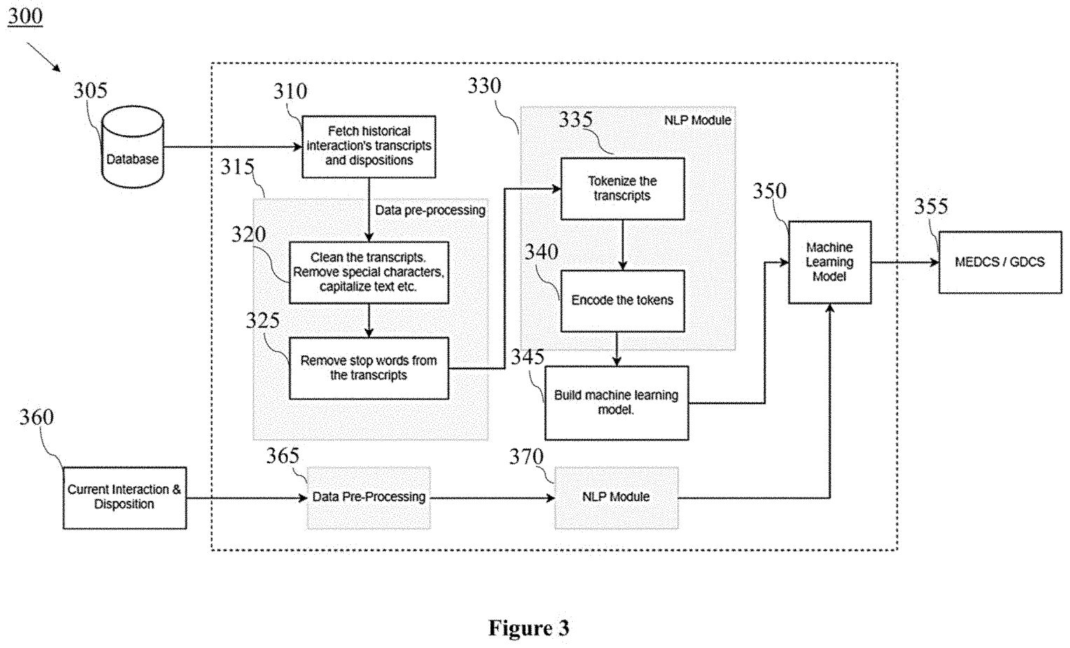

FIG. 3 schematically illustrates a high-level diagram of building an Artificial Intelligence (AI) module 300 to calculate a disposition confidence score related to the agent and a general disposition confidence score related to all agents, in accordance with some embodiments of the present disclosure.

According to some embodiments of the present disclosure, the pretrained AI model, such as machine learning model 350 and such as AI model 125 in FIGS. 1A-1B may be prebuilt by retrieving interactions transcripts and related dispositions during a preconfigured period, e.g., fetch historical interactions transcripts and dispositions 310 from a database, such as database 305 and such as database 110 in FIGS. 1A-1B.

According to some embodiments of the present disclosure, the retrieved interactions transcripts and related dispositions may be preprocessed 315 by cleaning the interactions transcripts, removing special characters and capitalizing text and the like 320. The data may be further preprocessed by removing stop words from the interactions transcripts 325.

According to some embodiments of the present disclosure, the preprocessed interactions transcripts and related disposition may be provided to a module such as an NLP module 330 to tokenize the transcripts 335, e.g., tokenize the preprocessed interactions transcripts into tokens and encode the tokens 340. The encoded tokens may be used to build the machine learning model 345 including training, into machine learning model 350, such as the AI model 125 in FIGS. 1A-1B to calculate a Manually Entered Disposition Confidence Score (MEDCS) and a General Disposition Confidence Score (GDCS) 355.

According to some embodiments of the present disclosure, the machine learning model 350, such as AI model 125 in FIGS. 1A-1B, may be provided an interaction transcript 360 after the interaction transcript has been preprocessed 365 and forwarded via a module, such as NLP module 370 to calculate the MEDCS and GDCS 355, which may be forwarded along with aggregated data related to the agent by a data aggregator, such as data aggregator module 150 to a module, such as disposition truthfulness calculator module 155 in FIGS. 1A-1B.

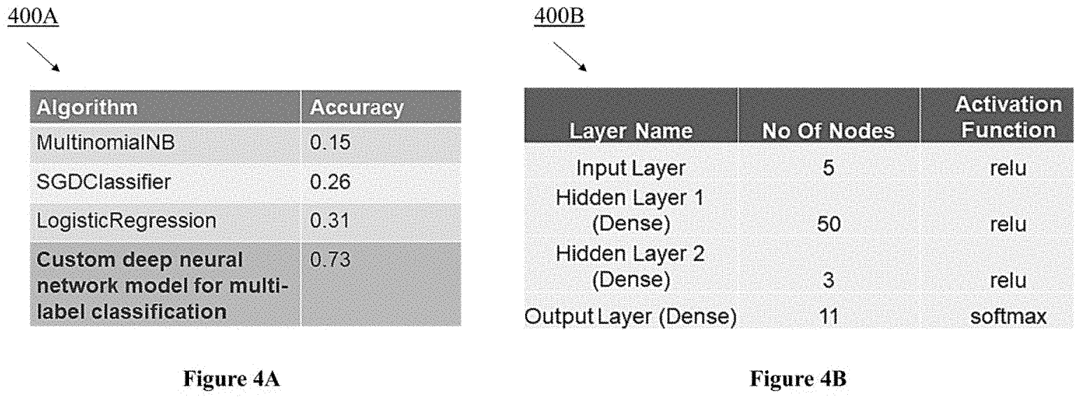

FIG. 4A is a table 400A showing a comparison of existing classification algorithms and computerized-method for identifying truthfulness of a disposition, in a contact center, in accordance with some embodiments of the present disclosure.

According to some embodiments of the present disclosure, table 400A is showing algorithms which are used in machine learning models and its related accuracy when implemented in an AI model such as AI model 125 in FIGS. 1A-1B. The AI model, such as AI model 125 in FIGS. 1A-1B may implement “Custom deep neural network model for multi-label classification” havening the highest accuracy.

FIG. 4B is a table 400B showing deep learning model summary, in accordance with some embodiments of the present disclosure.

According to some embodiments of the present disclosure, table 400B shows deep neural network model summary and its layers in order they gets executed, nodes assigned to each layer which is a computational unit that has one or more weighted input connections and the activation functions which helps the network to learn complex patterns in the data.

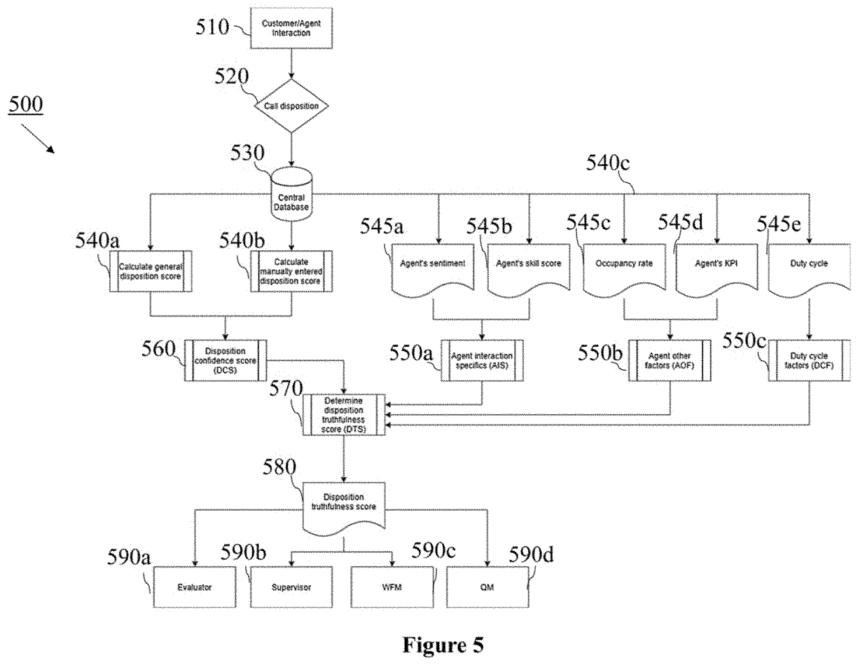

FIG. 5 is a high-level workflow of computerized-method for identifying truthfulness of a disposition, in a contact center in a contact center, in accordance with some embodiments of the present disclosure.

According to some embodiments of the present disclosure, after a customer/agent interaction 510 the agent may select a call disposition 520 to summarize the interaction. The call disposition may be stored in a central database 530.

According to some embodiments of the present disclosure, it may be significant for the contact center to validate the accuracy of the call disposition which has been selected by the agent. The interaction transcript and the related disposition may be provided to a prebuilt AI module, such as AI module 125 in FIGS. 1A-1B.

According to some embodiments of the present disclosure, the AI module, such as AI module 125 in FIGS. 1A-1B may calculate: (i) a disposition confidence score related to the agent, such as Manually Entered Disposition Confidence Score (MEDCS) 540b and such as MEDCS 135a in FIG. 1A; and (ii) a general disposition confidence score related to all agents, such as General Disposition Confidence Score (GDCS) 540a and such as GDCS 140a, in FIG. 1A.

According to some embodiments of the present disclosure, a data aggregator module, such as data aggregator module 150 in FIG. 1A-1B on a database, such as database 110 in FIGS. 1A-1B, may be operated to aggregate data related to the agent. The data related to the agent for the received interaction transcript of the interaction may be agent's sentiment score 545a for the interaction, occupancy rate of the agent for a specified period 545c, agent's skill score 545b, ratings and duty cycle factor for a specified period 545e. Agent's KPI 545d may be also retrieved from the database, such as database 110 in FIGS. 1A-1B. As to agent's skill score 545b, interactions not relevant to agent's top skills may impact on agent's disposition truthfulness score (DTS). As to ratings, an agent with a higher rating may be more accurate in determining the call disposition. An Agent KPI 545d may show the performance of the agent in handling the calls which may contribute to the call disposition truthfulness.

According to some embodiments of the present disclosure, the DCS 560, AIS 550a, AOF 550b and DCF 550c may be used to determine the Disposition Truthfulness Score 570. The Disposition Truthfulness Score (DTS) 580 may be calculated by a module, such as disposition truthfulness calculator module 155 in FIGS. 1A-1B. The DTS may be calculated by formula (I) as described above, (I) DTS=DCS+AIS+AOF−DCF.

According to some embodiments of the present disclosure, the Disposition Confidence Score (DCS) 560 may be calculated based on formula II, as described above,

$$DCS = ( \frac{MEDCS + GDCS}{2} ) \times F 1 \qquad ( II )$$

whereby MEDCS is a manually entered DCS, which is the calculated disposition confidence score 540b related to the agent, GDCS is a general DCS, which is the calculated disposition confidence score 540a related to all agents, and F1 is a weight.

According to some embodiments of the present disclosure, the Agent Interaction Specifics (AIS) 550a may be calculated based on formula III, as described above,

$$AIS = ( \frac{AS + ASS}{2} ) \times F 2 \qquad ( III )$$

whereby Agent Sentiment (AS) is Agent's sentiments score 545a for the interaction, Agent's skills score (ASS) 545b, and F2 is a weight.

According to some embodiments of the present disclosure, the Agent Other Factors (AOF) 550b may be calculated based on formula IV, as described above,

$$Agent Other Factors = ( \frac{AOR + AR}{2} ) \times F 3 \qquad ( IV )$$

whereby Agents Occupancy Rate (AOR) may be for a specified period, Agent Ratings (AR) and F3 is a weight.

According to some embodiments of the present disclosure, the Duty Cycle Factors (DCF) 545e may be calculated based on formula V, as described above, (V) DCF=RDCF×F4 whereby Raw Duty Cycle Factor (RDCF) 550c for a specified period, and F4 is a weight.

According to some embodiments of the present disclosure, the DTS 580 may be sent to the one or more applications, to take one or more follow-up actions based on the DTS 580, when the DTS is below a preconfigured disposition truthfulness threshold.

According to some embodiments of the present disclosure, the one or more applications may be evaluator 590a, supervisor 590b, Workforce Management (WFM) 590c and Quality Management (QM) 590d.

FIG. 6 is a screenshot 600 of a supervisor dashboard of the supervisor application, in accordance with some embodiments of the present disclosure.

According to some embodiments of the present disclosure, an average DTS score may be presented on a supervisor dashboard along with a summary of DTS e.g., greater than a specified value, less than a specified value or in the range of values.

According to some embodiments of the present disclosure, a supervisor dashboard, as shown by screenshot 600, may include a disposition truthfulness summary which may show different categories of call dispositions and an average disposition score. The average disposition score may show the average of all call dispositions within an organization or a team. This pictorial representation may aid a supervisor to understand the truthfulness of a disposition and to take further one or more actions.

FIG. 7 shows an example 700 of an implementation of a computerized-method and a computerized-system for identifying truthfulness of a disposition, in a contact center, in accordance with some embodiments of the present disclosure.

According to some embodiments of the present disclosure, when one application of the one or more applications, such as one or more applications 160 in FIG. 1A, may be a supervisor application 160a in FIG. 1B and the disposition 720 and related DTS, e.g., truthfulness score (1-10) 740, of each agent 710 may be displayed on a supervisor dashboard of the supervisor application 160a, via a display unit.

FIG. 8 shows an example 800 of an implementation of a computerized-method and a computerized-system for identifying truthfulness of a disposition, in a contact center, in accordance with some embodiments of the present disclosure.

Element 810 shows an accuracy of a predicted class, e.g., ‘1.0’ which has been operated for a disposition call such as, predicted disposition class: ‘product question’, for a received interaction transcript, such as element 820. In other words, the calculated Disposition Truthfulness Score (DTS), by a computerized-method for identifying truthfulness of a disposition, in a contact center, such as computerized-method 200 in FIGS. 2A-2B, as shown in element 810 is 100%, e.g., accuracy of predicted class: ‘1.0’.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for identifying truthfulness of a disposition, in a contact center, the computerized-method comprising:
(a) receiving an interaction transcript and related disposition of an interaction between an agent and a customer;
(b) providing the received interaction transcript and related disposition to an Artificial Intelligence (AI) model to calculate: (i) a disposition confidence score related to the agent; and (ii) a general disposition confidence score related to all agents;
(c) operating a data aggregator module on a database to aggregate data related to the agent;
(d) providing the disposition confidence score related to the agent, the general disposition confidence score related to all agents and the data related to the agent to a disposition truthfulness calculator module to calculate a Disposition Truthfulness Score (DTS); and
(e) sending the DTS to the one or more applications, to take one or more follow-up actions based on the DTS, when the DTS is below a preconfigured disposition truthfulness threshold.

2. The computerized-method of claim 1, wherein the AI model is prebuilt by:
(i) retrieving interactions transcripts and related dispositions during a preconfigured period;
(ii) preprocessing the retrieved interactions transcripts and related disposition;
(iii) providing the preprocessed interactions transcripts and related disposition to an NLP module to tokenize the preprocessed interactions transcripts into tokens and encode the tokens; and
(iv) using the encoded tokens to build and train the AI model.

3. The computerized-method of claim 1, wherein the related disposition is manually entered by an agent at the end of the interaction by selecting from a list of options.

4. The computerized-method of claim 1, wherein the disposition confidence score related to the agent for the received interaction transcript of the interaction is calculated by the AI module by operating a Manually Entered Disposition Confidence Score (MEDCS) module based on agent's interactions transcripts and dispositions related to interactions conducted in a preconfigured period by the agent and the received interaction transcript and related disposition of the interaction between the agent and the customer.

5. The computerized-method of claim 1, wherein the general disposition confidence score related to all agents for the received interaction transcript of the interaction is calculated by the AI module by operating a General Disposition Confidence Score (GDCS) module and wherein said GDCS module is based on agents interactions transcripts and dispositions related to interactions conducted in a preconfigured period by all agents and the received interaction transcript and related disposition of the interaction between the agent and the customer.

6. The computerized-method of claim 1, wherein the aggregated data related to the agent for the received interaction transcript of the interaction is agent's sentiment score for the interaction, occupancy rate of the agent for a specified period, skills, ratings and duty cycle factor for a specified period.

7. The computerized-method of claim 1, wherein one application of the one or more applications is a Quality Management (QM) application.

8. The computerized-method of claim 7, wherein the one or more follow-up actions of the QM application based on the disposition truthfulness score is assigning a coaching program by an evaluator.

9. The computerized-method of claim 1, wherein one application of the one or more applications is a Workforce Management (WFM) application.

10. The computerized-method of claim 9, wherein the one or more follow-up actions of the WFM application based on the disposition truthfulness score includes an optimized assignment to agents.

11. The computerized-method of claim 1, wherein one application of the one or more applications is a supervisor application, and wherein the computerized-method is further comprising displaying the disposition confidence score related to the agent on a supervisor dashboard of the supervisor application, via a display unit.

12. The computerized-method of claim 11, wherein the one or more follow-up actions of the supervisor application based on the disposition truthfulness score includes a supervisor agent communication.

13. The computerized-method of claim 1, wherein the DTS is calculated based on formula I:
DTS=DCS+AIS+AOF−DCF (VI)
whereby:
DCS is calculated based on formula II,
$$Disposition Confidence Score = ( \frac{MEDCS + GDCS}{2} ) \times F 1 \qquad ( II )$$
whereby:
MEDCS is a Manually Entered DCS, which is the calculated disposition confidence score related to the agent,
GDCS is a General DCS, which is the calculated disposition confidence score related to all agents, and
F1 is a weight;
AIS is calculated based on formula III:
$$Agent Interaction Specifics = ( \frac{AS + ASS}{2} ) \times F 2 \qquad ( VII )$$
whereby:
AS is Agent's sentiments score for the interaction,
ASS is Agent's skills score,
F2 is a weight;
AOF is calculated based on formula IV:
$$Agent Other Factors = ( \frac{AOR + AR}{2} ) \times F 3 \qquad ( VIII )$$
whereby:
AOR is Agents Occupancy Rate for a specified period, and
AR is Agent ratings;
F3 is a weight;
and
DCF is calculated based on formula V:
Duty Cycle Factors=RDCF×F4 (IX)
whereby:
RDCF is Raw Duty Cycle Factor for a specified period, and
F4 is a weight.

14. A computerized-system for identifying truthfulness of a disposition, in a contact center, the computerized-system comprising:
one or more processors;
a database; and
a memory to store the database,
said one or more processors are configured to:
(a) receive an interaction transcript and related disposition of an interaction between an agent and a customer;
(b) provide the received interaction transcript and related disposition to an Artificial Intelligence (AI) model to calculate: (i) a confidence disposition score related to the agent; and (ii) a general disposition confidence score related to all agents;
(c) operate a data aggregator module on the database to aggregate data related to the agent;
(d) provide the disposition confidence score related to the agent, the general disposition confidence score related to all agents and the data related to the agent to a disposition truthfulness calculator module to calculate a Disposition Truthfulness Score (DTS); and
(e) send the DTS to the one or more applications, to take one or more follow-up actions based on the DTS, when the DTS is below a preconfigured disposition truthfulness threshold.
